(19) United States
(12) Patent Application Publication
(10) Pub. No.: US 2008/0141682 A1
(43) Pub. Date: Jun. 19, 2008

(54) Product Dispensing Device and Refrigeration Method

(75) Inventors: Pierre Jeuch, Saint Aubin (FR); Lionel Frantz, Paris (FR); Fadi Khairallah, Versailles (FR)

Correspondence Address: GREENBERG TRAURIG, LLP, 1200 SEVENTEENTH STREET, SUITE 2400, DENVER, CO, 80202, US

(73) Assignee: THERMAGEN, SA, Batiment 5 (FR)

(21) Appl. No.: 11/816,698

(22) PCT Filed: Jan. 27, 2006
(86) PCT No.: PCT/FR06/00187

§ 371 Date: Sep. 12, 2007

(30) Foreign Application Priority Data
Feb. 22, 2005 (EP) 05290394.5

(51) Int. Cl. F25B 21/02; B67D 5/62

(52) U.S. Cl. 62/3.64; 62/389

(57) ABSTRACT

Devices and methods are set forth for providing a product dispenser comprising a refrigerating cavity designed to receive the product to be distributed in order to cool it down before its expulsion for use by a consumer.

### RELATED APPLICATIONS

This application claims the benefit, pursuant to 35 U.S.C. § 371, of European Patent Application EP 05290394.5, filed Feb. 22, 2005, and PCT Application PCT/FR2006/000187, filed Jan. 27, 2006, which applications are hereby incorporated herein by reference.

### BACKGROUND

There are numerous product dispensing devices on the market, in particular for washing hands. Such hygiene, care or treatment product dispensing devices generally comprise a manual pump type device that allows for the delivery of a small controlled quantity of product contained in a reservoir. These pump devices generally comprise two non-return valves, such as ball valves, for controlling the intake of the product into and its expulsion from a cavity equipped with a manually actuated piston.

Moreover, certain care or treatment products, for example cosmetic or medical, need to be applied cold. For certain products, their effectiveness is improved if they undergo a quenching effect, that is, rapid cooling just before use.

Thus self-refrigerating packages exist, making it possible to cool down their contents just before use. Reference can be made for example to the cosmetic product marketed under the name ice-source®, a description of which be found on the site www.ice-source.com. However, the known self-refrigerating packaging cools down all of the product that it contains and it is recommended to keep product not used after the quenching effect in a refrigerator. The quenching effect is then no longer present on subsequent use. Furthermore, the known self-refrigerating packaging does not allow delivery of the cooled product by expulsion of small controlled quantities.

Moreover, U.S. Pat. No. 4,802,343 describes a beverage-refrigerating device comprising a refrigerating cavity through which the beverage flows during its consumption. This device does not comprise a means of expulsion of a controlled quantity of refrigerated product but simply a duct causing the product to flow through the refrigerating cavity. Furthermore, the device described does make it possible to activate and stop the cooling of a given quantity of product several times.

U.S. Pat. No. 6,688,132 describes shipping container cooling system. The system comprises a means for restricting the flow of refrigerant liquid in order to control the refrigerating power by a controlled supply of refrigerant liquid from an external reservoir to the evaporator. The system described in this patent is intended to ensure refrigeration over a long period of time and does not allow for the refrigeration of controlled quantities of products expelled after cooling.

### SUMMARY

This invention relates to a product dispensing device, for example of viscous products such as care or hygiene creams for example. In particular, the invention relates to a refrigerated product dispensing device, that is, a dispensing device that makes it possible to cool down a controlled quantity of product just before its expulsion for use by a consumer.

To this end, this invention proposes a product dispenser comprising a refrigerating cavity designed to receive the product to be distributed in order to cool it down just before its expulsion for use by a consumer.

More particularly, the invention relates to a product dispensing device comprising: a refrigerating cavity designed to receive the product to be dispensed; a heat exchanger forming one wall of the refrigerating cavity; a means of cooling the heat exchanger; and a means of expulsion of the refrigerated product out of the refrigerating cavity. According to the embodiments, the dispensing device according to the invention also comprises one or more of the following characteristics: a reservoir of product to be refrigerated and means of intake of the product into the refrigerating cavity; a non-return valve between the product reservoir and the refrigerating cavity; a non-return valve between the refrigerating cavity and an expulsion zone external to the cavity; a blade that is mobile in translation in the refrigerating cavity; a blade that is mobile in rotation in the refrigerating cavity; a cylindrical heat exchanger; and a flat heat exchanger. According to one characteristic, the product expulsion means comprise: a fixed blade forming one wall of the refrigerating cavity; a mobile blade forming one wall of the refrigerating cavity; and a mobile assembly designed to drive the mobile blade in movement in the refrigerating cavity.

According to one characteristic, the product expulsion means also constitute the product intake means and a first blade is integral with the heat exchanger, a second blade is integral with the product reservoir and the mobile assembly is designed to drive a relative movement between the product reservoir and the heat exchanger.

According to another embodiment, the cooling means comprise: an evaporator designed to receive a refrigerant liquid and its vapour, one wall of the evaporator forming the heat exchanger; a reservoir containing means of pumping by adsorption of said vapour of the refrigerant liquid; and a connection between the evaporator and the pumping reservoir.

According to one embodiment, the cooling means comprise a Peltier element.

According to the embodiments, the dispensing device according to the invention also comprises one or more of the following characteristics: the cooling means are activated by opening the connection between the evaporator containing the refrigerant liquid and the pumping reservoir; the cooling means are stopped by obstruction of the connection between the evaporator containing the refrigerant liquid and the pumping reservoir; a valve is designed to obstruct said connection, a spring and a pressure element each being designed to constrain the valve in either the open or closed position respectively of the end of the connection tube; the cooling means are activated and stopped by the introduction of a controlled quantity of refrigerant liquid into the evaporator; a reservoir of refrigerant liquid and a peristaltic pump designed to deliver a controlled quantity of refrigerant liquid into the evaporator; a reservoir of refrigerant liquid and an obstructing assembly and a flow-rate limiter designed to deliver a controlled quantity of refrigerant liquid into the evaporator; the wall of the evaporator forming the heat exchanger is at least partially covered by a hydrophilic porous layer; the evaporator comprises a refrigerant liquid deflector; the means of cooling the heat exchanger are activated by the means of intake of the product into the refrigerating cavity; and/or the means of cooling the heat exchanger are activated by deformation of a wall element designed to create an opening between the evaporator containing the refrigerant liquid and the pumping reservoir.

The invention also relates to a method for refrigeration of a product to be dispensed, comprising stages involving: filling a refrigerating cavity with product to be dispensed, one wall of the refrigerating cavity forming a heat exchanger; activating means of cooling the heat exchanger; and expelling the refrigerated product out of the refrigerating cavity.

According to one characteristic, the filling of the refrigerating cavity with product to be dispensed is achieved by intake of product from a reservoir of product to be refrigerated.

According to one characteristic, the activation of the cooling means is triggered by the intake of product into the refrigerating cavity.

### BRIEF DESCRIPTION OF THE DRAWINGS

The features and advantages of this invention will become apparent during the following description, given as an illustrative and non-limitative example, and produced with reference to the figures, which show:

FIG. 1 illustrates an embodiment of a product dispensing device.

FIG. 2 illustrates cooling aspects of an embodiment of a product dispensing.

FIG. 3 illustrates intake and expulsion of product aspects of an embodiment of a product dispensing device.

FIG. 4 illustrates another embodiment of a product dispensing device.

FIG. 5 illustrates another embodiment of a product dispensing device.

FIG. 6a illustrates another embodiment of a product dispensing device.

FIG. 6b illustrates other intake and expulsion of product aspects of a product dispensing device.

FIG. 7 illustrates another embodiment of a product dispensing device.

### DETAILED DESCRIPTION

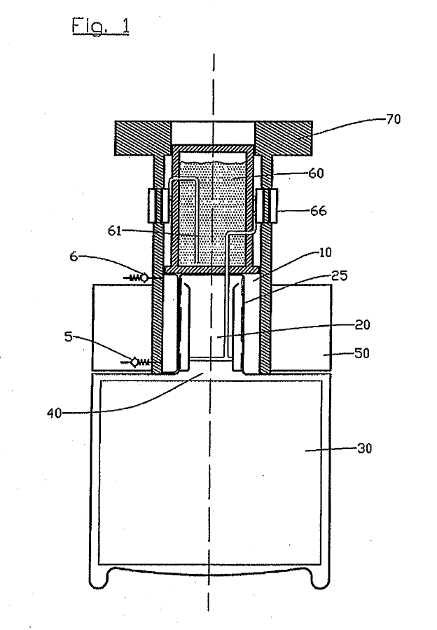

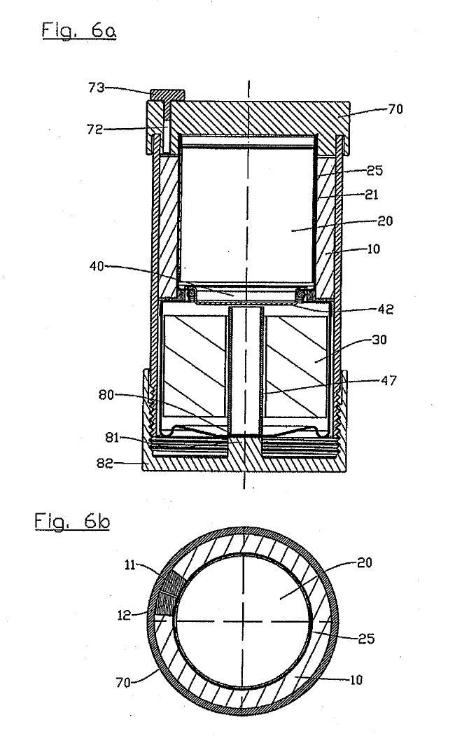

FIG. 1 shows a refrigerating cavity 10 that can receive a product to be dispensed. The product can be placed in the refrigerating cavity during the marketing of the dispensing device, as will be described more fully with reference to FIG. 6, or be taken into the refrigerating cavity just before its cooling and its expulsion for use. The product to be dispensed can be viscous, that is, the product exhibits a certain resistance to flow. It may be a cosmetic or medical care cream or a food product. The dispensing device according to the invention can also be used for liquid products, such as serums, in particular if the latter must be used in small quantities.

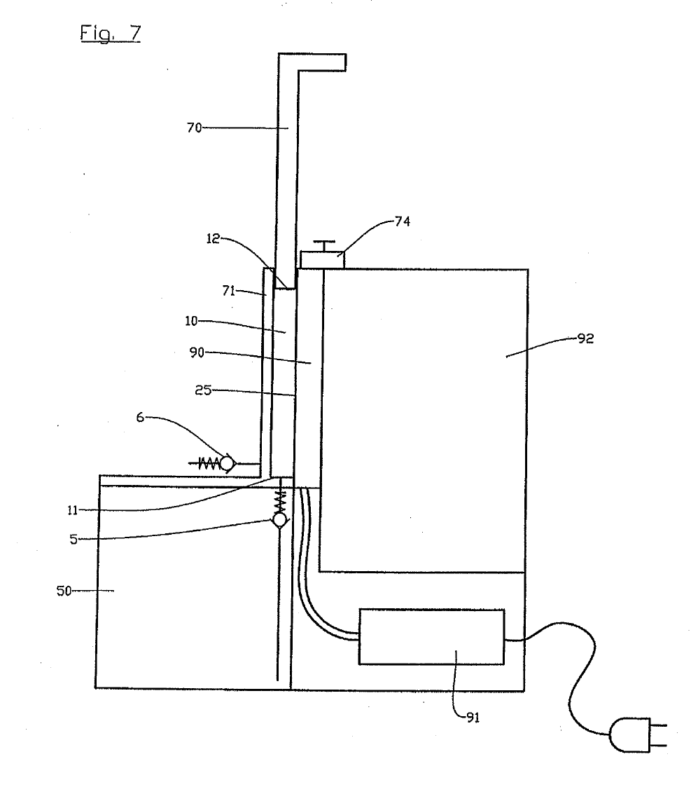

FIG. 1 also shows a heat exchanger 25 forming one wall of the refrigerating cavity 10. According to the embodiment illustrated in FIG. 1, the heat exchanger 25 is cylindrical and the refrigerating cavity 10 is delimited by two coaxial cylinders, the inside cylinder being constituted by the heat exchanger 25. The heat exchanger can however have any other appropriate shape, for example flat, with a cavity rectangular in shape, as illustrated in FIG. 7.

FIG. 1 also shows means of cooling the heat exchanger. In FIG. 1, these cooling means are based on a method of cooling by adsorption evaporation, the principle of which involves evaporating a liquid under the effect of low pressure maintained by adsorption of the vapours of said liquid. Reference can be made to patent applications EP-A-1 444938 and EP-A-1 481204 for the implementation of such a cooling method.

In particular, the means of cooling of the product dispensing device in FIG. 1 comprise an evaporator 20 designed to receive a refrigerant liquid and its vapour and a reservoir 30 containing means of pumping by adsorption of said vapour of the refrigerant liquid, for example a block of desiccant as described in patent application EP-A-1 297287. A connection 40 between the evaporator 20 and the pumping reservoir 30 is provided in order to allow the adsorption of the vapours of the refrigerant liquid and thus the cooling of the heat exchanger 25 and therefore of the product contained in the refrigerating cavity 10. To this end, the heat exchanger 25 forms a wall common to the evaporator 20 and the refrigerating cavity 10.

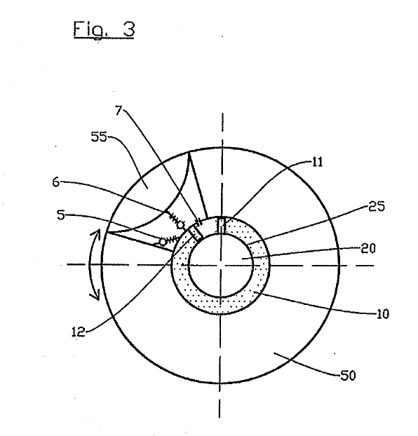

FIG. 1 also shows a reservoir 50 of product to be refrigerated. This reservoir 50 contains the care, hygiene or other product to be dispensed. A controlled quantity of product is introduced into the refrigerating cavity 10 in order to be cooled there before being expelled outside for use. The refrigerated product dispensing device according to the invention thus comprises means of intake of the product to be refrigerated into the refrigerating cavity 10 and means of expulsion of the refrigerated product out of said cavity, which are described in detail with reference to FIG. 3.

A non-return valve 5 can be provided between the product reservoir 50 and the refrigerating cavity 10 in order to avoid any backward flow of cooled product from the cavity 10 towards the reservoir 50. A non-return valve 6 can also be provided between the refrigerating cavity 10 and an expulsion zone external to the cavity in order to avoid any entry of air in the refrigerating cavity during the aspiration of the product to be refrigerated into said cavity.

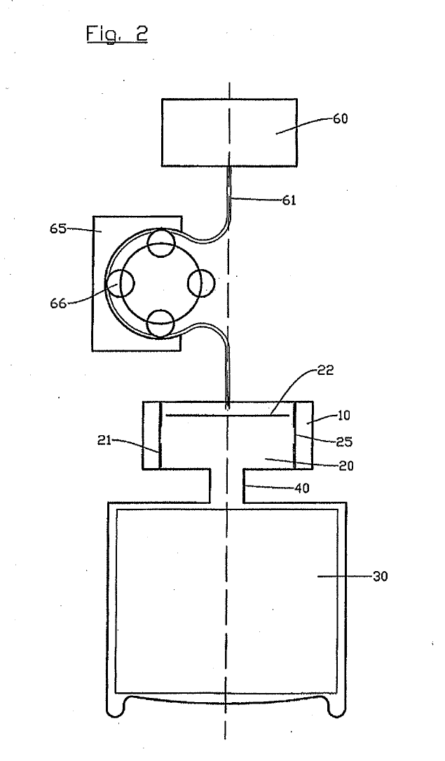

In FIG. 1, the cooling reaction is activated and controlled by introduction of refrigerant liquid into the evaporator 20. FIG. 2 illustrates in more detailed manner the control of the cooling according to this first embodiment.

The evaporator 20 and the pumping reservoir 30 are in open connection, the assembly being kept under vacuum. Typically, before the first cooling reaction, the vacuum in the evaporator 20 is less than 1 mbar at 23° C. Thus, a liquid introduced into the evaporator 20 is immediately evaporated and pumped by the desiccant contained in the pumping reservoir 30, thus causing cooling of the evaporator and therefore of the heat exchanger 25, which constitutes one wall of the evaporator.

In order to control the triggering of the cooling, a flexible tube 61 connects a reservoir of refrigerant liquid 60, containing water for example, to the evaporator 20. This tube 61 passes through a peristaltic pump 65 making it possible to deliver a controlled quantity of liquid in bursts. The tube 61 is squeezed by rollers 66 against an external cylindrical bore (FIG. 2) or against an internal cylinder (FIG. 1); the rotation of the rollers carries the liquid contained in the tube 61 between two rollers. The liquid reservoir 60 is not at any time directly connected to the evaporator 20 as there is always at least one roller 66, and preferably two rollers, obstructing the connection by crushing the tube 61.

In order to improve the cooling, the evaporator 20 contains a deflector 22 that diverts the jet of liquid water towards the walls forming the heat exchanger 25 covered with a hydrophilic porous layer 21. This water, by evaporating, cools down the exchanger 25 and the product contained in the refrigerating cavity 10 in contact with the exchanger. The cooling is thus triggered by introduction of refrigerant liquid into the evaporator 20 and stopped when all of the vapours of the refrigerant liquid have been adsorbed. The peristaltic pump 65 is therefore dimensioned with an internal diameter of the tube 61, a number of rollers 66 and a clearance between the rollers corresponding to a given quantity of water necessary for the satisfactory cooling of the volume of the refrigerating cavity 10.

With reference to FIG. 1, the activation of the cooling is ensured by a mobile assembly 70, in rotation in the embodiment in FIG. 1, which drives the rollers 66 against the tube 61 rolled on the walls of the fixed liquid reservoir 60.

The product dispensing device according to the invention is designed to cool a given quantity of product, and then expel this cooled product to the outside for use.

FIG. 3 illustrates in detail a possible embodiment for the intake of a controlled quantity of product into the refrigerating cavity and for its expulsion after cooling.

FIG. 3 shows a cross-section of the product reservoir 50, the refrigerating cavity 10, as well as the evaporator 20 and the heat exchanger 25 forming a common wall between the evaporator 20 and the refrigerating cavity 10. FIG. 3 also shows the non-return valves 5 and 6, between the product reservoir 50 and the refrigerating cavity 10 and between the refrigerating cavity 10 and a zone of expulsion 55 of the cooled product respectively.

FIG. 3 also shows product intake and expulsion means. According to the embodiment in FIG. 3, these intake and expulsion means comprise a fixed blade 11 and a mobile blade 12 arranged in the refrigerating cavity 10. A first blade, for example the fixed blade 11, is integral with the heat exchanger 25. A second blade, for example the mobile blade 12, is integral with the product reservoir 50. The product reservoir 50 is mobile relative to the heat exchanger 25. More specifically, the product reservoir 50 is mobile in rotation relative to the refrigerating cavity 10 and the evaporator 20, which remain fixed. When the reservoir 50 is driven in rotation about the refrigerating cavity 10, the mobile blade 12 integral with the reservoir is displaced in said cavity 10. The volume of the refrigerating cavity 10 is thus delimited by a common wall with the reservoir 50, a common wall with the evaporator 20 constituting the heat exchanger 25, and the fixed 11 and mobile 12 blades.

Although not illustrated and more complex to implement, it would be possible to keep the product reservoir 50 fixed and turn the evaporator 20/refrigerating cavity 10 assembly; the blade 11 integral with the heat exchanger 25 would then be mobile and the blade 12 integral with the reservoir 50 would be fixed.

The suction of product to be refrigerated from the reservoir 50 towards the refrigerating cavity 10 is carried out as follows. The use of the words right, left and trigonometric direction refers to FIG. 3 and is not limitative of the implementation of the invention.

When the cavity 10 is empty of product, the mobile blade 12 is located approximately abutting against the right side of the fixed blade 11. The reservoir 50 is driven in rotation, in the anti-trigonometric direction. The mobile blade 12 integral with the reservoir is then driven and moves away from the fixed blade 11. The vacuum created between the two blades 11, 12 makes it possible to open the non-return valve 5 between the reservoir 50 and the refrigerating cavity 10. Product is thus drawn into the cavity 10 in the gap between the two blades 11, 12. In FIG. 3, the refrigerating cavity 10 is almost full, the mobile blade 12 being almost abutting against the left side of the fixed blade 11. A controlled quantity of product can thus be cooled by the dispenser according to the invention, this quantity being defined by the volume of the cavity 10. A vent 7 allows the air trapped in the cavity 10 to escape during this filling operation.

The expulsion of the cooled product out of the refrigerating cavity 10 is then carried out in the following manner.

When the cavity 10 is full of product, the mobile blade 12 is located approximately abutting against the left side of the fixed blade 11. Once the cooling reaction is completed, the reservoir 50 is driven in rotation, in the trigonometric direction. The mobile blade 12 integral with the reservoir is then driven and moves towards the right side of the fixed blade 11. The mobile blade 12 then pushes the product, which makes it possible to open the non-return valve 6 between the refrigerating cavity 10 and an external expulsion zone 55. Cooled product is thus expelled out of the cavity 10 for use by a consumer.

With reference to FIG. 1, the intake of the product, then its expulsion, are ensured by the mobile assembly 70 that drives the reservoir 50 in rotation relative to the refrigerating cavity 10. The intake of the product into the refrigerating cavity from the reservoir 50 can thus be coupled with the introduction of water into the evaporator 20 in order to trigger the cooling reaction. The drive of the mobile assembly 70 can be manual, with the user turning the mobile assembly 70 in one direction then in the other by hand. A thermochromic label can be applied to an external wall of the refrigerating cavity 10 in order to indicate to the user that the contents of the cavity are sufficiently cold and ready for use. The drive of the mobile assembly 70 can also be partially manual, with the user turning the mobile assembly 70 in order to draw product and trigger the cooling reaction, the reverse rotation of the mobile assembly being for example ensured by a return spring released from a stop associated with a bimetallic strip (not shown) cooled at the same time as the product to be refrigerated.

Moreover, as the mobile assembly 70 also controls the triggering of the cooling reaction, the movement of the mobile element 70 must be chosen in combination with the arrangement of the rollers 66 of the peristaltic pump 65. In particular, the travel of the element which is mobile in the anti-trigonometric direction (according to FIG. 3) must be sufficient to introduce into the evaporator 20 all of the refrigerant liquid contained between the tube 61 extremity in the water reservoir 60 and extremity roller of the pump 65 on the side of the evaporator 20. The sections of tube between the rollers remain under vacuum until they open onto the reservoir 60, when they fill with refrigerant liquid with a view to the next use of the device.

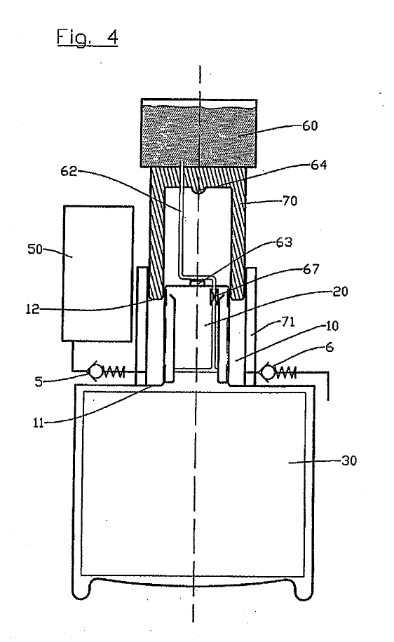

FIG. 4 illustrates another embodiment of the product dispenser according to the invention. The elements identical or similar to FIG. 1 are designated by the same reference numbers.

FIG. 4 shows a refrigerating cavity 10, an evaporator 20 and a reservoir 30 containing desiccants. FIG. 4 also shows a reservoir 50 of product to be refrigerated, as well as non-return valves 5 and 6 between the reservoir 50 and the refrigerating cavity 10 and between said cavity 10 and an expulsion zone.

In FIG. 4, the cooling reaction is also activated and controlled by introduction of refrigerant liquid into the evaporator 20. The evaporator 20 and the pumping reservoir 30 are therefore in open connection, the assembly being kept under vacuum. A reservoir of refrigerant liquid 60 is connected to the evaporator 20 by a tube 62 comprising a flow-rate limiter 67. In order to control the triggering of the cooling, the tube 62 passes through an obstructing assembly 63, 64, for example made up of a recess 63 designed to receive a boss 64.

With reference to FIG. 4, the activation and stopping of the cooling are driven by an assembly 70 mobile in translation that drives the boss 64 out of, and respectively into, the recess 63 in order to release, or respectively squeeze, the tube 62. When the tube is squeezed, the evaporation reaction is stopped due to a shortage of refrigerant liquid when the latter has finished being evaporated and pumped. When the tube is released, the cooling reaction can take place by adsorption of the vapours of the refrigerant liquid introduced by the tube 62 through the flow-rate limiter. The flow-rate limiter makes it possible to limit the quantity of refrigerant liquid introduced in order to ensure appropriate cooling of the quantity of product to be refrigerated.

In FIG. 4, the intake and expulsion of the product are carried out in the following manner. The use of the words upper, lower, above and below refers to FIG. 4 and is not limitative of the implementation of the invention.

When the cavity 10 is empty of product, the mobile assembly 70 is down into a bore 71 of the dispensing device delimiting the refrigerating cavity 10. The volume of the cavity 10 is therefore delimited by a common wall with the evaporator 20 forming a heat exchanger, an outer wall, a base forming a fixed blade 11 and the base of the mobile assembly constituting a mobile blade 12 in the cavity 10. The mobile assembly 70 is raised and the vacuum created between the fixed 11 and mobile 12 blades makes it possible to open the non-return valve 5 between the reservoir 50 and the refrigerating cavity 10; product can thus be drawn into the cavity 10. In FIG. 4, the refrigerating cavity 10 is full, the mobile assembly 70 being stopped in the upper position. A controlled quantity of product can thus be cooled by the dispenser according to the invention, this quantity being defined by the volume of the cavity 10.

When the cavity 10 is full of product, the mobile assembly 70 is situated above the cavity. Once the cooling reaction has taken place, the mobile assembly 70 is pushed downwards and thus pushes the product, which makes it possible to open the non-return valve 6 between the refrigerating cavity 10 and an external expulsion zone. Refrigerated product is thus expelled out of the cavity 10 for use by a consumer.

With reference to FIG. 4, the intake of the product, then its expulsion, are ensured by the mobile assembly 70 driving the mobile blade 12 in translation relative to the base 11 of the refrigerating cavity 10. The intake of the product into the refrigerating cavity from the reservoir 50 can thus be coupled with the introduction of water into the evaporator 20 in order to trigger the cooling reaction; the mobile assembly 70 drives the boss 64 out of the recess 63 in order to release the tube 62 when it is raised in order to draw the product. Similarly, the expulsion of the product out of the refrigerating cavity 10 can be coupled with the stopping of the cooling reaction; the mobile assembly 70 drives the boss 64 into the recess 63 in order to squeeze the tube 62 when it is depressed in order to expel the product.

In contrast to the embodiment of FIG. 1, the cooling reaction does not stop by itself when the water introduced into the evaporator 20 has been evaporated and pumped, or ultimately, when the reservoir of refrigerant liquid 60 is empty but it is then impossible to cool down further doses of product. In fact, when the obstructing assembly 63, 34 is open, the evaporator 20 is in direct connection with the reservoir of refrigerant liquid 60 and the cooling reaction is stopped only when this connection is obstructed by closure of the obstructing assembly 63, 64. A consumer can therefore prolong the cooling reaction if he wishes to receive a particularly cold dose of product, but there is a risk of inattention from a consumer forgetting the mobile assembly 70 in the upper position (with reference to FIG. 4) which could lead to breaking into, or even emptying, the reservoir 60 and reducing the number of doses of product that can be cooled just before expulsion. It must be noted that the dispensing device always operates in order to dispense product as long as the product reservoir 50 contains some, even if the doses can no longer be cooled.

In order to limit these risks, a thermochromic label on an outside wall of the refrigerating cavity 10 can indicate to the consumer that the dose of product is ready for use. The mobile assembly 70 can also be driven downwards into the closed position of the obstructing assembly 63, 64 by a return spring released from a stop associated with a bimetallic strip cooled at the same time as the product.

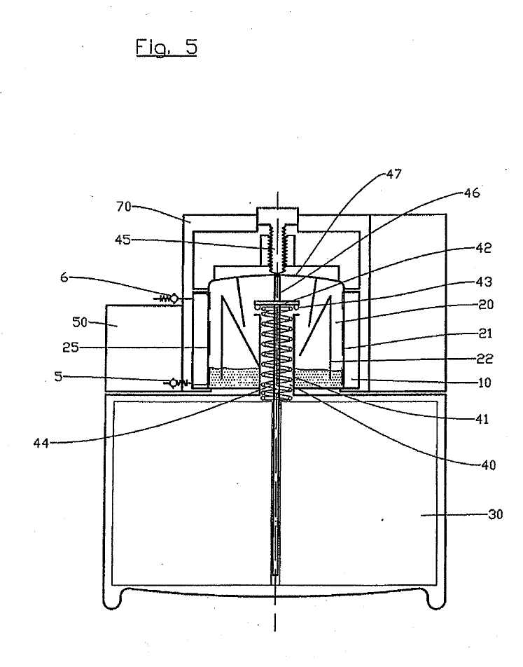

FIG. 5 shows another embodiment of the product dispensing device according to the invention. Elements identical or similar to FIG. 1 are designated by the same reference numbers. The use of the words upper, lower, above and below refers to FIG. 5 and is not limitative of the implementation of the invention.

FIG. 5 shows a refrigerating cavity 10, an evaporator 20 with a heat exchanger 25 forming a common wall between the evaporator 20 and the refrigerating cavity 10, and a reservoir 30 containing desiccants. FIG. 5 also shows non-return valves 5 and 6 between the reservoir 50 and the refrigerating cavity 10 and between said cavity 10 and an expulsion zone. In FIG. 5, the cooling reaction is activated and controlled by opening and closing the connection between the evaporator 20 and the pumping reservoir 30.

The evaporator 20 contains refrigerant liquid and the vapours of said liquid, in particular the evaporator is not connected to a reservoir of refrigerant liquid as in the embodiments described previously. The connection between the evaporator 20 and the pumping reservoir 30 containing desiccants can be opened and closed, the assembly being kept under vacuum. Typically, before the first opening, the saturating vapour pressure in the evaporator 20 is less than 30 mbar and the pressure in the pumping reservoir is less than 1 mbar at 23° C. Thus, when the connection between the evaporator 20 and the pumping reservoir 30 is opened, the vapours of the refrigerant liquid are immediately pumped by the desiccant contained in the pumping reservoir, thus causing a cooling of the evaporator and therefore of the heat exchanger 25 which constitutes one wall of the evaporator. A certain quantity of refrigerant liquid is also evaporated during the pumping of the vapours of said liquid contained in the evaporator. Thus, when the connection between the evaporator 20 and the pumping reservoir 30 is closed, the evaporator 20 still contains refrigerant liquid and vapours of said liquid.

During the production of the dispensing device according to the invention, the quantity of refrigerant liquid placed in the evaporator is calculated for evaporation of approximately 0.2 ml per dose to be cooled, a dose containing approximately 5 ml of product. The total quantity of refrigerant liquid contained in the evaporator therefore depends on the size of the product reservoir 50 associated with the dispensing device.

With reference to FIG. 5, the connection 40 between the evaporator 20 and the pumping reservoir 30 comprises a connection tube 41 opening at one end into the pumping reservoir 30 and at the other end into the evaporator 20, preferably at the top of the evaporator, that is, above the refrigerant liquid; thus only the vapours of the liquid can normally enter the tube 41. The end of the tube 41 opening into the evaporator 20 is obstructed by a valve 42 with a seal 43 ensuring tightness with the pumping reservoir when the connection is closed, for example an elastomer o-ring.

The opening of the valve 42 is actuated in order to open the connection between the evaporator 20 and the pumping reservoir 30, by a spring 44 resting on the tube 41 or on walls of the pumping reservoir. At rest, the spring 44 acts on the valve 42 in order to release the end of the tube 41 and allow the adsorption of the vapours of the refrigerant liquid. The closing of the valve 42 in order to close the connection between the evaporator 20 and the pumping reservoir 30 is activated by a set screw 45 designed to push the valve 42 against the constraint of the spring 44. Although not illustrated, it would be possible to envisage a configuration in which the spring 44 constrains the valve 42 in closed position with a pressure element designed to push the valve 42 into an open position.

In FIG. 5, the set screw 45 deforms the upper wall of the evaporator 20, shaped as a dome in the absence of constraint; a guide rod 46 extends between this upper wall and the valve 42 in order to transmit the deformation of the wall of the evaporator to the valve. The guide rod 46 can pass through the valve 42 and extend into the connection tube 41 between the coils of the spring 44 and as far as into the pumping reservoir 30 in order to hold the valve 42 well centred on the tube 41 and coaxial with the opening of the pumping reservoir 30 and the top of the dome deformed by the set screw 45.

The set screw 45 can be driven by a mobile assembly 70. In FIG. 5, the mobile assembly 70 can be rotated about the evaporator 20 and the refrigerating cavity 10, which remain fixed. The mobile assembly 70 drives the set screw 45 through one thread pitch, in a first direction in order to withdraw from the dome of the evaporator 20 and release the pressure exerted on the valve 42 against the spring 44 in order to initiate the cooling reaction, and in the other direction in order to depress the dome and push the valve against the end of the tube 41 in order to stop the cooling reaction.

FIG. 5 also shows a deflector [22] arranged in the evaporator 20 and a hydrophilic layer 21 covering the internal wall of the evaporator 20 forming the heat exchanger 25. The hydrophilic layer makes it possible to distribute refrigerant liquid along the heat-exchange wall 25 in order to increase the evaporation and therefore the cooling on this zone. The deflector does not have the function of diverting a jet of water against the heat exchanger as in the embodiments described with reference to FIGS. 1 to 4, but makes it possible to avoid droplets of refrigerant liquid splashing directly into the tube 41. In fact, when the valve 42 is open, the pumping force of the vapours of refrigerant liquid can be such that drops of liquid can be carried into the desiccant and limit its adsorption capacity. It is therefore necessary to provide a deflector that lets through the vapours of the refrigerant liquid to be pumped and that sends the drops of liquid to the bottom of the evaporator. Such a deflector is described in patent application EP-A-1 448290.

In FIG. 5, the intake and the expulsion of the product into and out of the refrigerating cavity are carried out in a manner similar to that described with reference to FIG. 3. A fixed blade and a mobile blade (not visible in the cross-section in FIG. 5 as they are coincident with the cross-section of the refrigerating cavity) are arranged in the refrigerating cavity 10. A dose of product is drawn into the refrigerating cavity from the product reservoir 50 by rotation of the mobile blade forming a vacuum between the two blades; this dose, once cooled, is expelled out of the refrigerating cavity by rotation of the mobile blade in the opposite direction, which pushes the product out of the cavity.

With reference to FIG. 5, the intake of the product, then its expulsion, are ensured by a mobile assembly 70 driving the mobile blade integral with the reservoir 50 in rotation relative to the fixed blade integral with the heat exchanger 25 in the refrigerating cavity 10. The intake of the product into the refrigerating cavity from the reservoir 50 can thus be coupled with the displacement of the valve 42 in order to open the connection between the evaporator 20 and the desiccant reservoir 30 in order to trigger the cooling reaction; the mobile assembly 70 simultaneously drives the mobile blade in order to draw product and the set screw 45 in order to release the valve 42 from the constraint of reaction to the spring 44, which then moves the valve away from the end of the connection tube 41. Similarly, the expulsion of the product out of the refrigerating cavity 10 can be coupled with the stopping of the cooling reaction; the mobile assembly 70 simultaneously drives the mobile blade in order to expel the product and the set screw in order to push the valve 42 against the end of the connection tube 41.

Although not illustrated, the set screw 45, or any similar element designed to act on the position of the valve 42 in relation to the end of the connection tube 41, can be driven by an assembly mobile in translation as illustrated in FIG. 4 with an intake and an expulsion of the product into and out of the refrigerating cavity 10 coupled with this translation movement.

In contrast to the embodiment in FIG. 1, the cooling reaction does not stop by itself when the water introduced into the evaporator 20 has been evaporated and pumped, or ultimately, when all the refrigerant liquid has been evaporated and adsorbed but it is then impossible to cool down further doses of product. In fact, when the set screw 45 is positioned with the valve 42 open, the refrigerant liquid vapours contained in the evaporator 20 are pumped continuously until the valve 42 is closed again. A consumer can therefore prolong the cooling reaction if he wishes to receive a dose of particularly cold product, but there is a risk of inattention from the consumer forgetting the mobile assembly 70 with the screw 45 in the upper position (with reference to FIG. 5) which could lead to breaking into, or even emptying, the reserves of refrigerant liquid in the evaporator 20 and thus reduce the number of doses of product that can be cooled just before expulsion. In order to limit these risks, a thermochromic label on an external wall of the refrigerating cavity 10 can indicate to the consumer that the dose of product is ready for use. The mobile assembly 70 can also be driven in a closed position, that is, depression of the screw 45 in order to close the valve 42 by a return spring released from a stop associated with a mechanical delay, for example a bimetallic strip cooled at the same time as the product.

FIGS. 6a and 6b illustrate another embodiment of the product dispensing device according to the invention. The elements identical or similar to FIG. 1 are designated by the same reference numbers.

FIG. 6a shows a refrigerating cavity 10, an evaporator 20 with a heat exchanger 25 forming a common wall between the evaporator 20 and the refrigerating cavity 10, and a reservoir 30 containing desiccants.

In FIG. 6a, the evaporator 20 contains refrigerant liquid and the vapours of said liquid, in particular the evaporator is not connected to a reservoir of refrigerant liquid as for the embodiments in FIGS. 1 to 4; the cooling reaction is activated by opening of the connection 40 between the evaporator 20 containing the refrigerant liquid and the pumping reservoir 30. In the embodiment in FIG. 6a, the cooling reaction is not stopped by the consumer but stops by itself when all the refrigerant liquid contained in the evaporator 20 has been evaporated and adsorbed. The dispensing device according to the embodiment in FIGS. 6a and 6b does not comprise a product reservoir. In fact, the product to be cooled, then expelled, is already contained in the refrigerating cavity 10.

According to this embodiment, even though the product to be cooled is not taken into the refrigerating cavity 10 as previously described, it is nevertheless expelled after cooling. In fact, a possible application of such a refrigerated product dispensing device is to be able to dispense a mini-dose of cooled product to a consumer. Mini-dose is given to mean a dose of product corresponding to a typical sample dose, i.e., approximately 3 ml, as opposed to the contents of a cream jar such as the abovementioned product ice-source®, which cools down approximately 20 ml of cream. The expulsion of the cream out of the packaging makes use much easier, in particular for application on the move.

The invention therefore makes it possible to produce a product dispensing device with reduced dimensions, which is less bulky than the ice-source® product. The device in FIG. 6a has a diameter of approximately 25 mm for a length of 100 mm, whereas the ice-source® jar has a diameter of 8 cm for a height of 5 cm.

The cooling of the product contained in the refrigerating cavity 10 is activated by a push rod 47 actuating a non-return valve 42 obstructing an opening provided between the evaporator 20 and the desiccant reservoir 30. The opening of the valve 42 thus causes the evaporation of the refrigerant liquid contained in the evaporator 20 from which the vapour is pumped by the desiccants, this evaporation then causing a cooling of the evaporator and therefore of the heat exchanger 25 in contact with the refrigerating cavity. Such a mechanism connecting the evaporator 20 to the pumping reservoir 30 is described in patent application EP-A-1 481204.

The non-return valve 42 is actuated by the push rod 47 transmitting a displacement of at least one portion from the bottom of the pumping reservoir 30. The bottom of the desiccant reservoir 30 has a deformable zone 80 against which the push rod 47 rests. To actuate the cooling process, the deformable zone 80 is depressed, using a button 81 placed in a knob 82 screwed into the bottom of the casing of the device according to the invention. Thus, by screwing the knob 82, the button 81 depresses the deformable zone 80 which drives the rod 47 upwards and pushes the valve 42 into the open position. The screwing of the knob 82 depressing the deformable zone allows for effortless depression for the consumer. In fact, given the small diameter of the device, the depression of the deformable zone 80 with the finger would require a relatively significant effort; it is however understood that the deformable zone 80 can be depressed with the finger or with any mechanism other than the knob 82 and the button 81 illustrated.

The evaporator 20 does not comprise a deflector as in FIG. 5, as practically all of the refrigerant liquid is contained in the hydrophilic porous layer 21 distributed along the wall of the heat exchanger 25; there is therefore no risk of squirting of droplets towards the adsorbent. In fact, given the small quantity of product to be refrigerated, approximately 0.3 ml of water is sufficient. The integration of a deflector however remains possible if needed.

Once the cooling reaction is over, optionally shown by a thermochromic label for the consumer, the cooled product can be expelled. FIG. 6b shows a possible embodiment for the expulsion of the product out of the refrigerating cavity 10 of the device in FIG. 6a. A fixed blade 11 and a mobile blade 12 are arranged in the refrigerating cavity 10. The fixed blade 11 is integral with the heat exchanger 25 and the mobile blade 12 is integral with a mobile assembly 70 made up for example of a knob that is mobile in rotation on top of the casing of the device. The mobile assembly 70 can have an orifice for the expulsion of the product 72 obstructed by a clipped or screwed plug 73, as illustrated in FIG. 6a. In order to collect the cooled product, the consumer removes the plug 73 and turns the mobile knob 70 which will drive the mobile blade 12. The rotation of the blade 12 pushes the product out of the cavity 10 through the expulsion orifice 72 where the consumer can collect it

Although not illustrated, it is understood that other methods of expulsion can be associated with the dispensing device in FIG. 6, in particular, the mobile assembly can be driven in translation rather than in rotation, in the manner illustrated in FIG. 4.

FIG. 7 shows another embodiment of the product dispensing device according to the invention. The elements identical or similar to FIG. 1 are designated by the same reference numbers.

FIG. 7 shows a refrigerating cavity 10 and a reservoir 50 of product to be refrigerated, as well as non-return valves 5 and 6 between the reservoir 50 and the refrigerating cavity 10 and between said cavity 10 and an expulsion zone. FIG. 7 also shows a mobile assembly 70.

In FIG. 7, the cooling reaction is activated and controlled by a Peltier element 90 connected to a power supply 91. A Peltier element conventionally comprises semi-conductor elements between two conducting layers. The circulation of the current leads on the one hand to absorption of heat at the level of one layer, the so-called cold side, and on the other hand a release of heat in the other layer, the so-called hot side. The cold side of the Peltier element 90 constitutes a wall of the refrigerating cavity and serves as a flat heat exchanger 25. The hot side of the Peltier element 90 can be placed in contact with a heat sink 92, for example a water reservoir, to keep the hot side at ambient temperature.

In FIG. 7, the intake and expulsion of the product are carried out in the following manner. The use of the words upper, lower, above and below refers to FIG. 7 and is not limitative of the implementation of the invention.

When the cavity 10 is empty of product, the mobile assembly 70 is down into a bore 71 of the dispensing device delimiting the refrigerating cavity 10. The volume of the cavity 10 is therefore delimited by a common wall with the Peltier element 90 forming a heat exchanger 25, the bore 71, a base forming a fixed blade 11 and the base of the mobile assembly constituting a mobile blade 12 in the cavity 10. The mobile assembly 70 is raised and the vacuum created between the fixed 11 and mobile 12 blades makes it possible to open the non-return valve 5 between the reservoir 50 and the refrigerating cavity 10; product can thus be drawn into the cavity 10. In FIG. 7, the refrigerating cavity 10 is full, the mobile assembly 70 being stopped in the upper position. A controlled quantity of product can thus be cooled by the dispensing device according to the invention, this quantity being defined by the volume of the cavity 10.

When the cavity 10 is full of product, the mobile assembly 70 is situated above the cavity. Once the cooling has been carried out, the mobile assembly 70 is pushed downwards and then pushes the product back, which makes it possible to open the non-return valve 6 between the refrigerating cavity 10 and an external expulsion zone. Cooled product is thus expelled out of the cavity 10 for use by a consumer.

With reference to FIG. 7, the intake of the product, then its expulsion, are ensured by the mobile assembly 70 driving the mobile blade 12 in translation relative to the base 11 of the refrigerating cavity 10. The intake of the product into the refrigerating cavity from the reservoir 50 can also be coupled with the starting-up of the Peltier element 90 in order to trigger the cooling reaction; the mobile assembly 70 is shaped in order to actuate an on-off switch 74 which is configured to power the Peltier element when it is not depressed by the mobile element 70. Similarly, the expulsion of the product out of the refrigerating cavity 10 can be coupled with the stopping of the cooling reaction; the mobile assembly 70 depresses the switch 74 to interrupt the powering of the Peltier element 90 when it is depressed in order to expel the product.

Of course, the cooling by a Peltier element 90 can be associated with another method of intake and expulsion of the product in and out of the refrigerating cavity 10, for example with an element that is mobile in rotation as described with reference to FIGS. 1, 3, 5 and 6.

Of course, this invention is not limited to the embodiments described by way of example; thus, the different methods of cooling and of intake/expulsion of the product can be combined with each other differently from the implementations described with reference to the figures. Similarly, the form and the arrangement of the elements of the dispensing device can vary, notably the form and location of the product reservoir relative to the refrigerating cavity.

1. A product dispensing device comprising:
a refrigerating cavity designed to receive the product to be dispensed;
a heat exchanger forming one wall of the refrigerating cavity;
a means of cooling the heat exchanger; and
a means of expulsion of the refrigerated product out of the refrigerating cavity.

2. The product dispensing device of claim 1, further comprising:
a reservoir of product to be refrigerated; and
a means of intake of the product into the refrigerating cavity.

3. The product dispensing device of claim 2, further comprising a non-return valve between the product reservoir and the refrigerating cavity.

4. The product dispensing device of claim 1, further comprising a non-return valve between the refrigerating cavity and an expulsion zone external to the cavity.

5-6. (canceled)

7. Product dispensing device comprising:
a refrigerating cavity designed to receive the product to be dispensed;
a heat exchanger forming one wall of the refrigerating cavity;
a means of cooling the heat exchanger; and
a means of expulsion of the refrigerated product out of the refrigerating cavity,
wherein said expulsion means comprise:
a fixed blade forming one wall of the refrigerating cavity;
a mobile blade forming one wall of the refrigerating cavity; and
a mobile assembly designed to drive the mobile blade in movement in the refrigerating cavity.

8. The product dispensing device of claim 7, further comprising a reservoir of product to be refrigerated, wherein the means of expulsion of the product also constitute means of intake of the product into the refrigerating cavity, and wherein:
a first blade is integral with the heat exchanger;
a second blade is integral with the product reservoir; and
the mobile assembly is designed to drive a relative movement between the product reservoir and the heat exchanger.

9. The product dispensing device of claim 7, wherein the mobile blade is mobile in translation in the refrigerating cavity.

10. (canceled)

11. The product dispensing device of claim 7, wherein the mobile blade is mobile in rotation in the refrigerating cavity.

12-16. (canceled)

17. The product dispensing device of claim 1, wherein the cooling means comprise a Peltier element.

18. The product dispensing device of claim 7, wherein the cooling means comprise a Peltier element.

19. The product dispensing device of claim 1, wherein the cooling means comprise:
an evaporator designed to receive a refrigerant liquid and its vapour, one wall of the evaporator forming the heat exchanger;
a reservoir containing means of pumping by adsorption of said vapour of the refrigerant liquid; and
a connection between the evaporator and the pumping reservoir.

20. The product dispensing device of claim 7, wherein the cooling means comprise:
an evaporator designed to receive a refrigerant liquid and its vapour, one wall of the evaporator forming the heat exchanger;
a reservoir containing means of pumping by adsorption of said vapour of the refrigerant liquid; and
a connection between the evaporator and the pumping reservoir.

21. The product dispensing device of claim 19, wherein the cooling means are activated by opening the connection between the evaporator containing the refrigerant liquid and the pumping reservoir.

22. The product dispensing device of claim 21, wherein the cooling means are stopped by obstructing the connection between the evaporator containing the refrigerant liquid and the pumping reservoir.

23. The product dispensing device of claim 21, further comprising:
a valve designed to obstruct said connection; and
a spring and a pressure element each designed to constrain the valve respectively in either the open or closed position of the end of the connection tube.

24. The product dispensing device of claim 22, further comprising:
a valve designed to obstruct said connection; and
a spring and a pressure element each designed to constrain the valve respectively in either the open or closed position of the end of the connection tube.

25. The product dispensing device of claim 19, wherein the cooling means are activated and stopped by the introduction of a controlled quantity of refrigerant liquid into the evaporator.

26. The product dispensing device of claim 25, further comprising a reservoir of refrigerant liquid and a peristaltic pump designed to deliver a controlled quantity of refrigerant liquid into the evaporator.

27. The product dispensing device of claim 25, further comprising a reservoir of refrigerant liquid and an obstructing assembly and a flow-rate limiter designed to deliver a controlled quantity of refrigerant liquid into the evaporator.

28-29. (canceled)

30. The product dispensing device of claim 2, wherein the cooling means are activated by the means of intake of the product into the refrigerating cavity.

31. The product dispensing device of claim 8, wherein the cooling means are activated by the means of intake of the product into the refrigerating cavity.

32. The product dispensing device of claim 19, wherein the cooling means are activated by deformation of a wall element designed to create an opening between the evaporator containing the refrigerant liquid and the pumping reservoir.

33. Method for refrigeration of a product to be dispensed, comprising stages involving:
filling a refrigerating cavity with product to be dispensed, one wall of the refrigerating cavity forming a heat exchanger;
activating means of cooling the heat exchanger; and
expelling the refrigerated product out of the refrigerating cavity.

34. Refrigeration method of claim 33, in which the filling of the refrigerating cavity with product to be dispensed is achieved by intake of product from a reservoir of product to be refrigerated.

35. Refrigeration method of claim 34, in which the activation of the cooling means is triggered by the intake of product into the refrigerating cavity.

36-37. (canceled)
